(19) United States
(12) Patent Application Publication
(10) Pub. No.: US 2025/0370718 A1
(43) Pub. Date: Dec. 4, 2025

(54) SYSTEMS AND METHODS FOR GENERATING JOINTLY CERTIFIABLE RANDOMNESS AND PROVIDING JOINTLY CERTIFIABLE RANDOMNESS VIA PUBLICLY-CERTIFIABLE RANDOMNESS BEACONS

(71) Applicant: JPMORGAN CHASE BANK, N.A., New York, NY (US)

(72) Inventors: Omar AMER, New York, NY (US); Shouvanik CHAKRABARTI, Jersey City, NJ (US); Niraj KUMAR, Amsterdam (NL); Pradeep NIROULA, College Park, MD (US); Ruslan SHAYDULIN, New York, NY (US); Marco PISTOIA, Amawalk, NY (US); Andrew LANG, Avon, CT (US)

(21) Appl. No.: 18/680,190

(22) Filed: May 31, 2024

(51) Int. Cl. G06F 7/58

(52) U.S. Cl. CPC G06F 7/588

(57) ABSTRACT

A method may include: selecting, by a plurality of classical parties, each of the classical parties using a classical party computer program, a distributed randomness protocol; generating, by the plurality of classical parties, a random string using the selected distributed randomness protocol; providing, by one of the classical parties, the random string to a quantum party, wherein the quantum party executes a quantum party computer program in communication with a quantum randomness source; executing, by the quantum party, a certified randomness protocol with the quantum randomness source using the random string as an input; receiving, by the quantum party, quantum randomness comprising a sequence of random bits from the quantum randomness source; and verifying, by the classical parties, that the random string was randomly selected, and that the quantum randomness is a valid output of the certified randomness protocol using the random string as input.

### BACKGROUND OF THE INVENTION

### 1. Field of the Invention

Embodiments relate to systems and methods for generating jointly certifiable randomness and providing jointly certifiable randomness via publicly-certifiable randomness beacons.

### 2. Description of the Related Art

Randomness plays an important role in many processes, but it is highly non-trivial to extract randomness from classical systems. Thus, randomness is often simulated or approximated, for example, for analysis, decision making, optimization, encryption, lottery, management of resourcing, gaming, creativity, electronic elections, etc.

Certified randomness protocols exist that allow for a classical party interacting with a trusted quantum computer to verify that a set of strings are sampled from the output of specified quantum circuits, or otherwise that they are the result of some quantum process. These protocols allow the classical party to bound the min-entropy of the string under certain assumptions on the quantum computer, thereby certifying its randomness.

Existing certified randomness protocols are generally interactions between just the single classical party and quantum party, but one can imagine applications where multiple classical parties, some of whom may not be acting honestly, want to jointly agree on a certifiably random string, which existing protocols do not allow for.

One explicit application of this concept is in the use of public randomness beacons, in which an entity regularly publishes blocks of data that consumers should be able to trust as random. Public randomness beacons exist in the literature and in practice, but they require some trust that the sources being used are not compromised. Examples of public randomness beacons are described in Mayank Raikwar and Danilo Gligoroski, “Sok: Decentralized randomness beacon protocols,” Australasian Conference on Information Security and Privacy, pp. 420-446 (2022), the disclosure of which is hereby incorporated, by reference in its entirety.

### SUMMARY OF THE INVENTION

Systems and methods for generating jointly certifiable randomness and providing jointly certifiable randomness via publicly-certifiable randomness beacons are disclosed. According to an embodiment, a method may include: (1) selecting, by a plurality of classical parties, each of the classical parties using a classical party computer program, a distributed randomness protocol; (2) generating, by the plurality of classical parties, a random string using the selected distributed randomness protocol; (3) providing, by one of the classical parties, the random string to a quantum party, wherein the quantum party executes a quantum party computer program in communication with a quantum randomness source; (4) executing, by the quantum party, a certified randomness protocol with the quantum randomness source using the random string as an input; (5) receiving, by the quantum party, quantum randomness comprising a sequence of random bits from the quantum randomness source; and (6) verifying, by the classical parties, that the random string was randomly selected, and that the quantum randomness is a valid output of the certified randomness protocol using the random string as input.

In one embodiment, the distributed randomness protocol may be selected based on a network characteristic.

In one embodiment, the quantum party further receives certification information with the quantum randomness.

In one embodiment, the certification information may include descriptions of pseudo-random quantum circuits and outputs of the pseudo-random quantum circuits used in the certified randomness protocol.

In one embodiment, the method may also include: verifying, by at least one of the classical party computer programs, that the random string was randomly selected and that the quantum randomness is a valid output of the certified randomness protocol.

In one embodiment, the random string may include a plurality of random bits.

In one embodiment, the quantum randomness has a guaranteed randomness.

In one embodiment, the quantum randomness source may include a quantum computer.

According to another embodiment, a method may include: (1) obtaining, by a plurality of classical verifiers, each using a classical verifier computer program, and a quantum party using a quantum party computer program, a first quantum randomness and first certification information from a quantum randomness source; (2) making available, by a publicly-certifiable randomness beacon, the first certification information to consumers of randomness in a first block of randomness; (3) executing, by the quantum party, a certified randomness protocol with the quantum randomness source using a portion of the first quantum randomness as an input; (4) receiving, by the publicly-certifiable randomness beacon, a second quantum randomness and second certification information; (5) including, by the publicly-certifiable randomness beacon, the first quantum randomness, the first certification information, the second quantum randomness, and the second certification information as inputs to the first block of randomness; (6) publishing, by the publicly-certifiable randomness beacon, the first block of randomness; and (7) verifying, by the consumers of randomness, a randomness of the first block of randomness.

In one embodiment, the first certification information may include descriptions of pseudo-random quantum circuits and outputs of the pseudo-random quantum circuits used in the certified randomness protocol.

In one embodiment, the first block of randomness further may include the first certification information, the second quantum randomness, and the second certification information.

In one embodiment, the first quantum randomness may include a first sequence of random bits, and the second quantum randomness may include a second sequence of random bits.

In one embodiment, the first quantum randomness and the second quantum randomness wherein the quantum randomness each has a guaranteed randomness.

According to another embodiment, a system may include: a plurality of classical party electronic devices, each classical party electronic device executing a classical party computer program; a plurality of classical verifier electronic devices, each classical verifier electronic device executing a classical verifier computer program; a quantum party electronic device executing a quantum party computer program; a quantum randomness source; and a publicly-certifiable randomness beacon. The plurality of classical party computer programs generate a random string using a distributed randomness protocol; one of the classical party computer programs provides the random string to the quantum party computer program; the quantum party computer program executes a first certified randomness protocol with the quantum randomness source using the random string as an input; the quantum randomness source provides a first quantum randomness and first certification information to the quantum party computer program; the plurality of classical verifier computer programs and the quantum party computer program receives the first quantum randomness and the first certification information; the publicly-certifiable randomness beacon makes the first certification information available to consumers of randomness in a first block of randomness; the quantum party computer program executes a second certified randomness protocol with the quantum randomness source using a portion of the first quantum randomness as an input; the publicly-certifiable randomness beacon receives a second quantum randomness and second certification information; the publicly-certifiable randomness beacon includes the first quantum randomness, the first certification information, the second quantum randomness, and the second certification information as inputs to the first block of randomness; the publicly-certifiable randomness beacon publishes the first block of randomness; and the consumers of randomness verify a randomness of the first block of randomness.

In one embodiment, the random string may include a plurality of random bits.

In one embodiment, the first quantum randomness may include a first sequence of random bits, and the second quantum randomness may include a second sequence of random bits.

In one embodiment, the first certification information and/or the second certification information may include descriptions of pseudo-random quantum circuits and outputs of the pseudo-random quantum circuits used in the certified randomness protocol.

In one embodiment, the classical party computer program verify that the random string was randomly selected and that the first quantum randomness is a valid output of the first certified randomness protocol.

In one embodiment, the first certified randomness protocol and the second certified randomness protocol may be the same.

In one embodiment, the first quantum randomness and/or the second quantum randomness has a guaranteed randomness.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for generating jointly certifiable randomness and providing jointly certifiable randomness via publicly-certifiable randomness beacons;

FIG. 2 illustrates a method for generating jointly certifiable randomness according to an embodiment;

FIG. 3 illustrates a method for providing jointly certifiable randomness via publicly-certifiable randomness beacons according to an embodiment; and

FIG. 4 depicts an exemplary computing system for implementing aspects of the present disclosure.

### DETAILED DESCRIPTION OF PREFERRED EMBODIMENTS

Embodiments relate to systems and methods for generating jointly certifiable randomness and providing jointly certifiable randomness via publicly-certifiable randomness beacons.

Embodiments may involve one or more two-party certified randomness protocols. Examples of such protocols are described in Scott Aaronson and Shih-Han Hung, “Certified Randomness From Quantum Supremacy,” Proceedings of the 55th Annual ACM Symposium on Theory of Computing, pp. 933-944 (2023); Zvika Brakerski, et al., “A cryptographic test of quantumness and certifiable randomness from a single quantum device,” Journal of the ACM 68.5, pp. 1-47 (2021); and Takashi Yamakawa and Mark Zhandry. “Verifiable quantum advantage without structure,” 2022 IEEE 63rd Annual Symposium on Foundations of Computer Science (FOCS), pp. 69-74 (2022). The disclosure of each of these documents is hereby incorporated, by reference, in its entirety.

Embodiments may further use distributed randomness protocols, which are an example of a secure multiparty computation with various security guarantees depending on various assumptions on complexity theoretic objects (e.g., one-way functions, oblivious transfer, etc.) and/or the number of corrupted parties. Distributed randomness protocols allow participants with some uniformly random input strings to agree on one (potentially smaller) string of near uniform values, even if some are trying to bias the protocol. This is in contrast to the jointly certifiable randomness protocol discussed below, which allows participants to expand their input randomness into a larger string, and allows participants to certify the randomness of the output. Examples of distributed random protocols are described in Manuel Blum, “Coin flipping by telephone a protocol for solving impossible problems,” ACM SIGACT News 15.1, pp. 23-27 (1983); Amos Beimel, Eran Omri, and Ilan Orlov, “Protocols for multiparty coin toss with a dishonest majority,” Journal of Cryptology, 28.3, pp. 551-600 (2015); and Shafi Goldwasser, Yael Tauman Kalai, and Sunoo Park, “Adaptively secure coin-flipping, revisited,” International Colloquium on Automata, Languages, and Programming, pp. 663-674 (2015). The disclosure of each of these documents is hereby incorporated, by reference, in its entirety.

Any suitable distributed randomness protocol may be used, although depending on the protocol and network characteristics, qualitatively and/or quantitatively different guarantees are achieved by the certifiable randomness protocol. Different distributed randomness protocols may result in different biases in the overall output and may retain security only for different flavors and quantities of malicious participants.

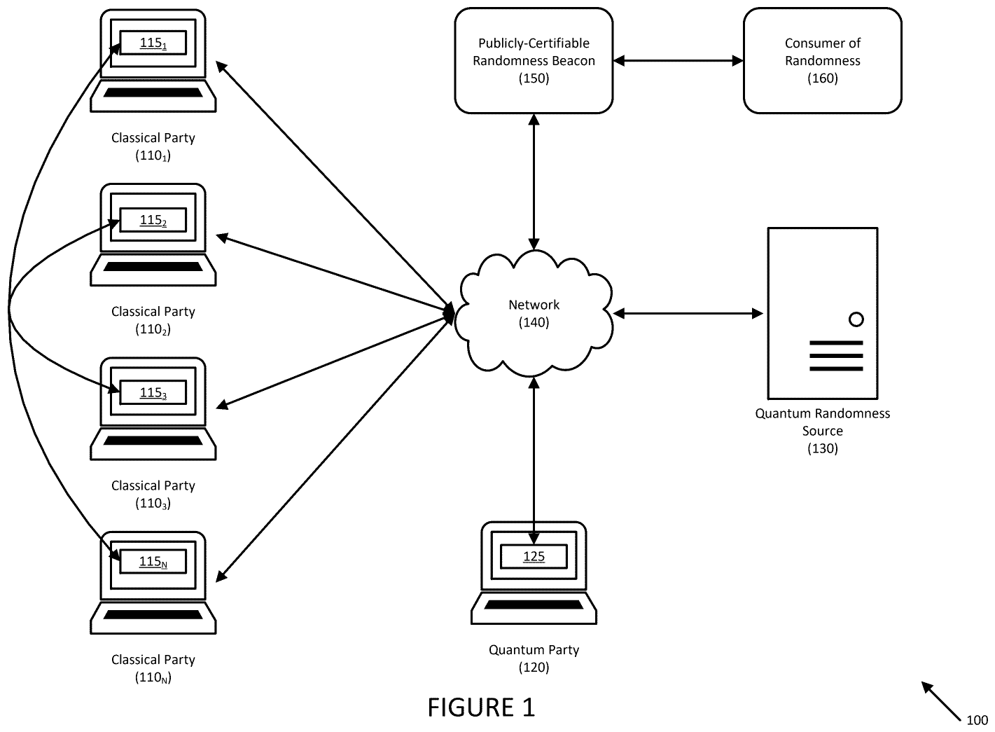

Referring to FIG. 1, a system generating jointly certifiable randomness and providing jointly certifiable randomness via publicly-certifiable randomness beacons is disclosed according to an embodiment. System 100 may include a plurality of classical parties 110 (e.g., classical party 110₁, classical party 110₂, classical party 110₃, . . . , classical party 110_{N}), and each classical party 110 may execute classical computer program 115 (e.g., classical computer program 115₁, classical computer program 115₂, classical computer program 115₃, . . . , classical computer program 115_{N}) on a classical computing device (e.g., workstation, desktop, laptop, notebook, tablet, etc.), a smart device (e.g., smart phone, smart watch, etc.), an Internet of Things (IoT) appliance, etc. Each classical party 110 may interface with quantum randomness source 130 via network 140, which may include, for example, the Internet.

Classical parties 110 may interact with each other in order to execute the distributed randomness protocol.

In one embodiment, classical parties 110 may also perform verification services, such as when used as classical verifiers for the certifiable randomness being output publicly-certifiable randomness beacon 150, providing their signatures to be included in blocks or otherwise offering validation services of the fact that they certify the randomness.

In another embodiment, classical verifiers (not shown) may be provided in addition to classical parties 110.

System 100 may further include quantum party 120, which may include a classical computer executing quantum party computer program 125. Quantum party computer program 125 may interface with quantum randomness source 130 over, for example, network 140. Quantum party 120 may execute a certifiable randomness protocol with quantum randomness source 130, resulting in quantum randomness (e.g., a sequence of random bits).

Quantum randomness source 130 may be a device that performs quantum computations, such as those based on the collective properties of quantum states including superposition, interference, and entanglement.

System 100 may further include publicly-certifiable randomness beacon 150. Publicly-certifiable randomness beacon 150 may be an electronic device (e.g., a server) that may interact with classical parties 110, quantum party 120, consumer of randomness 160, etc. using, for example, network 140, such as the Internet. In another embodiment, publicly-certifiable randomness beacon 150 may be provided on a private network.

Publicly-certifiable randomness beacon 150 may run a protocol that attempts to guarantee that multiple classical parties can fairly access public randomness that with certain guarantees on its bias or predictability. These protocols work by combining multiple sources of randomness by a public entity and publishing randomness derived from these sources at regular intervals. By integrating certified randomness into these protocols, classical parties can, under certain assumptions, verify that at least one of the sources used are indeed truly random, and therefore the publicly disclosed values are also random.

In embodiments, publicly-certifiable randomness beacon 150 may use multiple sources of randomness to create and publish a block of randomness, along with various other information (e.g., timestamps, source information, previous block information and/or hashes, etc.).

In one embodiment, consumer of randomness 160, which may be a computer program, application, etc. executed by an electronic device, may retrieve certified randomness from publicly-certifiable randomness beacon 150.

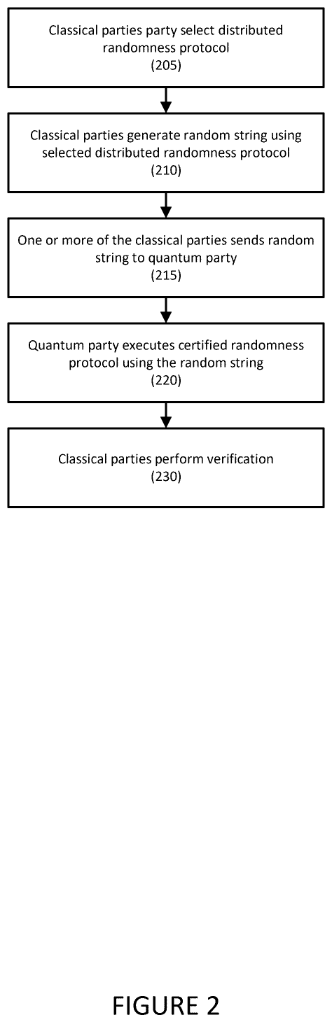

Referring to FIG. 2, a method for generating jointly certifiable randomness according to an embodiment.

In step 205, a plurality of classical parties may select a distributed randomness protocol based on an assumed maximum number of corrupted classical parties and any network characteristics. For example, if a minority of parties are assumed to be corrupt, the plurality of classical parties may use general secure multiparty computation results to distribute randomness (e.g., Ben-Or et al, “Completeness theorems for non-cryptographic fault-tolerant distributed computation,” STOC'88: Proceedings of the Twentieth Annual ACM Symposium On Theory Of Computing, pages 1-10 (1988), the disclosure of which is hereby incorporated, by reference, in its entirety), or if a majority of the plurality of classical parties are corrupt, they may use of Blum's coin flipping protocol (e.g., Blum, “Coin Flipping By Telephone A Protocol For Solving Impossible Problems,” ACM SIGACT News, Volume 15, Issue 1, pages 23-27 (1983), the disclosure of which is hereby incorporated, by reference, in its entirety).

For example, network characteristics (e.g., how freely classical parties can abort the protocol) and the maximum number of corrupted classical parties may be assumptions based on the behavior of the network. In embodiments, the network characteristics may be taken as assumptions on the part of the participants, informed by hardware, software, or network constraints, observed from prior operation, or otherwise enforced by some mechanisms.

In some embodiments, non-cryptographic mechanisms may be used to enforce the assumed behavior of the network. For example, economic or social incentives may be used to ensure that parties are not able to freely abort the protocol once started, a quality that is necessary for the security of certain distributed randomness protocols.

Examples of suitable distributed randomness protocol are described in Manuel Blum, “Coin flipping by telephone a protocol for solving impossible problems,” ACM SIGACT News 15.1, pp. 23-27 (1983); Amos Beimel, Eran Omri, and Ilan Orlov, “Protocols for multiparty coin toss with a dishonest majority,” Journal of Cryptology, 28.3, pp. 551-600 (2015); and Shafi Goldwasser, Yael Tauman Kalai, and Sunoo Park, “Adaptively secure coin-flipping, revisited,” International Colloquium on Automata, Languages, and Programming, pp. 663-674 (2015). The disclosure of each of these documents is hereby incorporated, by reference, in its entirety.

In step 210, the plurality of classical parties may use the selected distributed randomness protocol to generate and agree to a random string. The random string may include a plurality of random bits that are the output of the distributed randomness protocol.

In embodiments, the random string is smaller than the quantum randomness. In addition, the random string cannot be verified, while quantum randomness is certifiable.

In step 215, one or more of the plurality of classical parties may send the random string to a quantum party, such as a party that has access to a quantum randomness source (e.g., a quantum computer). Although only one party can send the random string to the quantum party, having multiple parties send the random string to the quantum party may ensure robustness in case one party declines to send it.

In step 220, the quantum party, using a computer program, may execute a certified randomness protocol using the random string as an input to generate a sequence of random bits along with any certification information needed by the underlying certified randomness protocol to verify that randomness. An example of a certified randomness protocol is disclosed in U.S. patent application Ser. No. 18/679,638, filed concurrently herewith, Attorney Docket No. 052227.501605, to Eloul, et al., entitled “Systems And Methods For Blockchain-Based Certified Random Function Using Quantum Random Circuit Generator,” and in U.S. patent application Ser. No. 18/625,605, the disclosure of each of which is hereby incorporated, by reference, in its entirety.

For example, in certifiable randomness protocols based on random circuits, certification information can include both the circuit descriptions and outputs of the circuits. Examples of such are described in Scott Aaronson and Shih-Han Hung, “Certified Randomness From Quantum Supremacy,” Proceedings of the 55th Annual ACM Symposium on Theory of Computing, pp. 933-944 (2023), the disclosure of which is hereby incorporated, by reference, in its entirety.

Examples of certification information may include additional bits that may not be random themselves but provide information about the internal state of the quantum randomness source that may be used to verify that the random bits are indeed random.

In step 230, the classical parties may verify that (a) the random string was randomly selected as they each played a role in selecting the random string and (b) that the sequences of random bits and the certification information are a valid output of the certified randomness protocol using the random string as input. Thus, the sequences of random bits have the randomness guaranteed by the certified randomness protocol.

It is notable that certain distributed randomness protocols and network scenarios may result in the random string exhibiting some bias, in which case the output of the described protocol may also exhibit some bias or otherwise fall short of the desired security properties. Embodiments may use different combinations of distributed randomness protocols, certified randomness protocols, and network settings, achieving qualitatively or quantitatively different guarantees according to each combination.

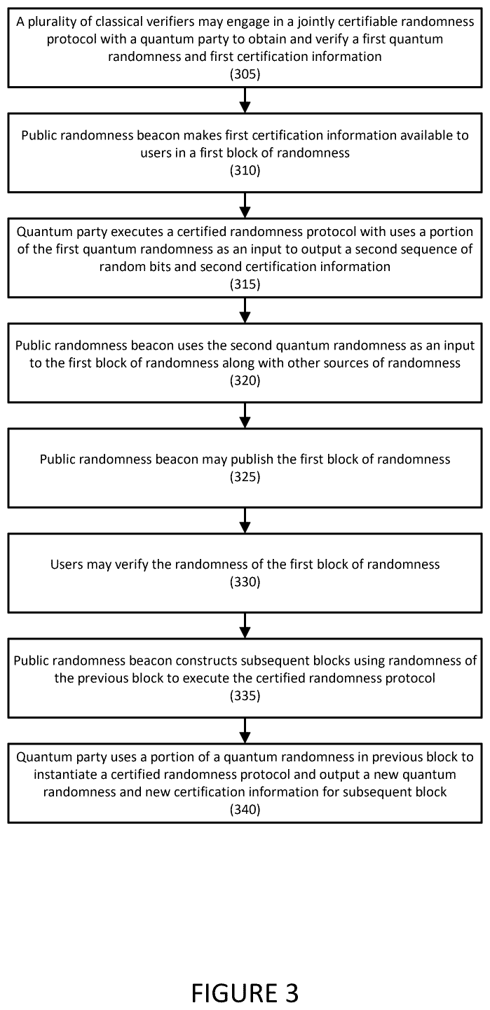

Referring to FIG. 3, a method for providing jointly certifiable randomness using publicly-certifiable randomness beacons is disclosed according to an embodiment.

In step 305, a plurality of classical verifiers may engage in a jointly certifiable randomness protocol with a quantum party to obtain and verify a first quantum randomness (e.g., a first sequence of random bits) and first certification information. In one embodiment, the process of FIG. 2 may be used to obtain the string of random bits and certification information.

In step 310, the publicly-certifiable randomness beacon, which may be a classical party, may make the first certification information available to users, such as consumers of randomness, by including the first certification information in a first block of randomness. The publicly-certifiable randomness beacon's verifiers may sign the first certification information with their digital signatures. Alternately, the users may retrieve the first certification information from one of the classical verifiers through other, potentially out-of-band, means.

In embodiments, a block of randomness may be considered to be a block of data that may include randomness, such as sequences of random bits. The structure may be specific to the publicly-certifiable randomness beacon that is used.

In step 315, a portion of the first quantum randomness may be used by the quantum party to instantiate a certified randomness protocol, which outputs a second quantum randomness (e.g., a second sequence of random bits) and second certification information. The quantum party may use, for example, the certified randomness protocol described above.

In step 320, the publicly-certifiable randomness beacon may use the second quantum randomness as an input to the first block of randomness along with other sources of randomness. In addition, the first quantum randomness, the first certification information, the second quantum randomness, and the second certification information may be included as supplementary information, as well as verifier identities.

In one embodiment, signatures of the classical verifiers (if used) and a transcript of the jointly certifiable randomness protocol may also be written to the first block of randomness. Any other information may be included as is necessary and/or desired.

In step 325, the publicly-certifiable randomness beacon may publish the first block of randomness using any suitable protocol used by the publicly-certifiable randomness beacon. Examples of such protocols are described in NIST, “A Reference for Randomness Beacons” available at doi.org/10.6028/NIST.IR.8213-draft, the disclosure of which is hereby incorporated by reference in its entirety.

In step 330, users, such as consumers of randomness, may verify the randomness of the first block of randomness by verifying a) that a majority of the verifiers provided their approval of the first random string used to generate the first quantum randomness and the first certification information, and (b) that the first quantum randomness and the first certification information are certifiably random based on the first random string according to the certifiable randomness protocol used; and (c) that the second quantum randomness and the second certification information are also certifiably random based on the second random string.

In some embodiments, the classical verifiers may take an active role and provide verifications of (b) and (c), again including either their signatures in the block (or subsequent blocks) or by publishing the information.

In step 335, subsequent blocks are constructed by the publicly-certifiable randomness beacon may use the randomness of the previous block to execute the certified randomness protocol to get an output for the current block, similar to what is described in step 315.

In step 340, verification of subsequent blocks of randomness may proceed as described above in step 330; however, the validity of each block of randomness is dependent on the validity of the previous block of randomness, and a new consumer of randomness verifying a block of randomness must verify all blocks since last time a sufficiently trustworthy set of verifiers provided validation. Thus, there is a trade-off between the barrier to entry to new users and the interaction of the verifiers.

In embodiments, user verification may be streamlined by having the classical verifiers provide signed verifications of each new block of randomness and/or provide new randomness frequently. Conversely, this requires the classical verifiers to be active more frequently, which can be reduced at the cost of having user's need to verify longer amounts of the chain before a new verifier-signed block is introduced. The use of classical verifiers necessitates some trust in the classical verifiers, but this can be distributed among a large enough set of classical verifiers.

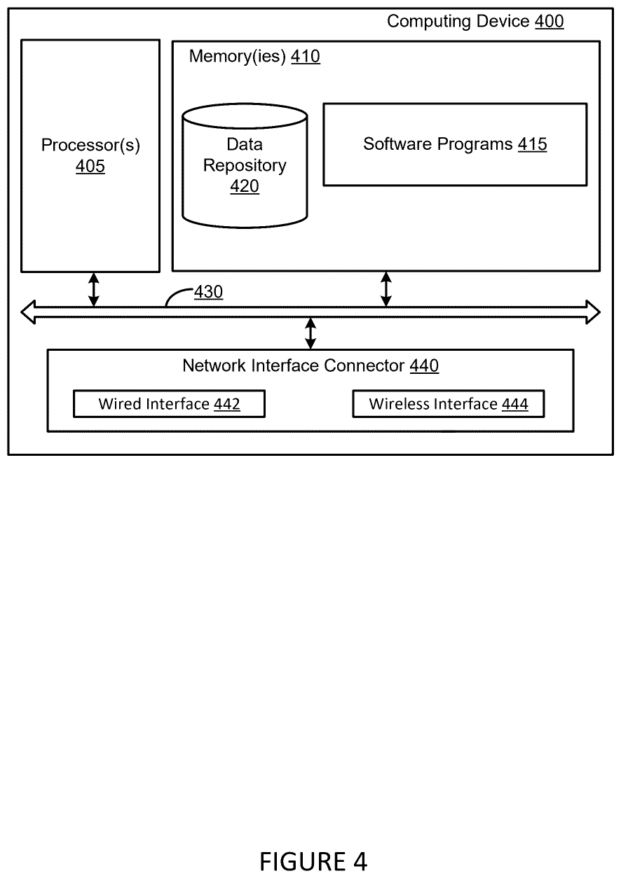

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

The disclosure of U.S. patent application Ser. No. 18/625,633, is hereby incorporated, by reference, in its entirety.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
selecting, by a plurality of classical parties, each of the classical parties using a classical party computer program, a distributed randomness protocol;
generating, by the plurality of classical parties, a random string using the selected distributed randomness protocol;
providing, by one of the classical parties, the random string to a quantum party, wherein the quantum party executes a quantum party computer program in communication with a quantum randomness source;
executing, by the quantum party, a certified randomness protocol with the quantum randomness source using the random string as an input;
receiving, by the quantum party, quantum randomness comprising a sequence of random bits from the quantum randomness source; and
verifying, by the classical parties, that the random string was randomly selected, and that the quantum randomness is a valid output of the certified randomness protocol using the random string as input.

2. The method of claim 1, wherein the distributed randomness protocol is selected based on a network characteristic.

3. The method of claim 1, wherein the quantum party further receives certification information with the quantum randomness.

4. The method of claim 3, wherein the certification information comprises descriptions of pseudo-random quantum circuits and outputs of the pseudo-random quantum circuits used in the certified randomness protocol.

5. The method of claim 1, further comprising:
verifying, by at least one of the classical party computer programs, that the random string was randomly selected and that the quantum randomness is a valid output of the certified randomness protocol.

6. The method of claim 1, wherein the random string comprises a plurality of random bits.

7. The method of claim 1, wherein the quantum randomness has a guaranteed randomness.

8. The method of claim 1, wherein the quantum randomness source comprises a quantum computer.

9. A method, comprising:
obtaining, by a plurality of classical verifiers, each using a classical verifier computer program, and a quantum party using a quantum party computer program, a first quantum randomness and first certification information from a quantum randomness source;
making available, by a publicly-certifiable randomness beacon, the first certification information to consumers of randomness in a first block of randomness;
executing, by the quantum party, a certified randomness protocol with the quantum randomness source using a portion of the first quantum randomness as an input;
receiving, by the publicly-certifiable randomness beacon, a second quantum randomness and second certification information;
including, by the publicly-certifiable randomness beacon, the first quantum randomness, the first certification information, the second quantum randomness, and the second certification information as inputs to the first block of randomness;
publishing, by the publicly-certifiable randomness beacon, the first block of randomness; and
verifying, by the consumers of randomness, a randomness of the first block of randomness.

10. The method of claim 9, wherein the first certification information comprises descriptions of pseudo-random quantum circuits and outputs of the pseudo-random quantum circuits used in the certified randomness protocol.

11. The method of claim 9, wherein the first block of randomness further comprises the first certification information, the second quantum randomness, and the second certification information.

12. The method of claim 9, wherein the first quantum randomness comprises a first sequence of random bits, and the second quantum randomness comprises a second sequence of random bits.

13. The method of claim 9, wherein the first quantum randomness and the second quantum randomness wherein the quantum randomness each has a guaranteed randomness.

14. A system, comprising:
a plurality of classical party electronic devices, each classical party electronic device executing a classical party computer program;
a plurality of classical verifier electronic devices, each classical verifier electronic device executing a classical verifier computer program;
a quantum party electronic device executing a quantum party computer program;
a quantum randomness source; and
a publicly-certifiable randomness beacon;
wherein:
the plurality of classical party computer programs generate a random string using a distributed randomness protocol;
one of the classical party computer programs provides the random string to the quantum party computer program;
the quantum party computer program executes a first certified randomness protocol with the quantum randomness source using the random string as an input;
the quantum randomness source provides a first quantum randomness and first certification information to the quantum party computer program;
the plurality of classical verifier computer programs and the quantum party computer program receives the first quantum randomness and the first certification information;
the publicly-certifiable randomness beacon makes the first certification information available to consumers of randomness in a first block of randomness;
the quantum party computer program executes a second certified randomness protocol with the quantum randomness source using a portion of the first quantum randomness as an input;
the publicly-certifiable randomness beacon receives a second quantum randomness and second certification information;
the publicly-certifiable randomness beacon includes the first quantum randomness, the first certification information, the second quantum randomness, and the second certification information as inputs to the first block of randomness;
the publicly-certifiable randomness beacon publishes the first block of randomness; and
the consumers of randomness verify a randomness of the first block of randomness.

15. The system of claim 14, wherein the random string comprises a plurality of random bits.

16. The system of claim 14, wherein the first quantum randomness comprises a first sequence of random bits, and the second quantum randomness comprises a second sequence of random bits.

17. The system of claim 14, wherein the first certification information and/or the second certification information comprises descriptions of pseudo-random quantum circuits and outputs of the pseudo-random quantum circuits used in the certified randomness protocol.

18. The system of claim 14, wherein the classical party computer program verify that the random string was randomly selected and that the first quantum randomness is a valid output of the first certified randomness protocol.

19. The system of claim 14, wherein the first certified randomness protocol and the second certified randomness protocol are the same.

20. The system of claim 14, wherein the first quantum randomness and/or the second quantum randomness has a guaranteed randomness.
